(19) United States
(12) Patent Application Publication
(10) Pub. No.: US 2014/0231180 A1
(43) Pub. Date: Aug. 21, 2014

(54) ELEVATOR SYSTEM

(71) Applicant: KONE Corporation, Helsinki (FI)

(72) Inventors: Antti Kallioniemi, Jokela (FI); Antti Plathin, Vantaa (FI)

(73) Assignee: KONE Corporation, Helsinki (FI)

(21) Appl. No.: 14/265,076

(22) Filed: Apr. 29, 2014

Related U.S. Application Data
(63) Continuation of application No. PCT/FI2012/050985, filed on Oct. 15, 2012.

(30) Foreign Application Priority Data
Nov. 13, 2011 (FI) 20116124

(51) Int. Cl. B66B 11/00

(52) U.S. Cl. CPC B66B 11/0045
USPC 187/256; 187/251; 187/254; 187/266

(57) ABSTRACT

An elevator system includes an elongated suspension member, a load-receiving part suspended on the suspension member, a counterweight suspended on the suspension member for supporting the load-receiving part, an elongated traction member for exerting a pulling force on the load-receiving part and on the counterweight, a drive unit, with which the load-receiving part is driven by pulling the traction member and also one or more guide rails, along the path of movement determined by which the load-receiving part is moved. The drive unit is disposed to the side of the path of movement of the load-receiving part.

### FIELD OF THE INVENTION

The invention relates to elevator systems, more particularly on and placement of elevator components in an elevator system.

### BACKGROUND OF THE INVENTION

Elevators are used for lifting a load in varying operating sites. An elevator usually comprises an elevator car, a lifting platform or a corresponding load-receiving part, with which a load is transferred. The load-receiving part, with counterweight, is suspended on an elongated suspension member that is continuous in the vertical direction, such as on a rope or belt. The load-receiving part is moved along a vertical track guided by a guide rail.

The driving force for moving the load-receiving part is usually produced with a separate drive unit. The drive unit comprises an electric motor. Some elevators comprise, in addition to the aforementioned suspension member, a separate elongated traction member, such as a belt having friction traction or tooth traction, which transmits the driving force produced by the electric motor into a force pulling the load-receiving part, with which force the load-receiving part is moved. One such solution is presented in international patent publication no. WO03/043927 A2, wherein FIGS. 8 and 9 diagrammatically present an elevator, in which the suspension function of the elevator car as well as the power transmission function of the hoisting machine are implemented with separate suspension members/traction members.

The driving force is transmitted from the electric motor to the traction member with a traction sheave pulling by friction or by gears belonging to the drive unit. The traction sheave is attached to the rotating rotor or shaft of the electric motor. Supply of the driving power to the electric motor most generally occurs e.g. with a power supply device comprising controllable solid-state switches, such as with a frequency converter.

In modern elevator systems without machine rooms, the drive unit is disposed in the elevator hoistway, in which case a separate machine room is not needed. This type of solution saves built space. Space-saving is anyway a growing trend both in fabricating new elevators and in modernizing old elevators, in which case a new elevator system must be fitted into the existing old elevator hoistway. Fitting a new elevator system into the existing old elevator hoistway can be challenging owing to, inter alia, the small top safety spaces and small bottom safety spaces of the elevator hoistway.

By means of the space-saving o be achieved in an elevator system, the proportion of space available for transporting elevator passengers out of the total volume of the elevator hoistway can be optimized, which increases the transport capacity of the elevator system.

Taking the preceding into account, there is a need for greater space-savings than before and for space-efficiency when developing new elevator systems.

### AIM OF THE INVENTION

The aim of the present invention is to solve the aforementioned problems as well as the problems disclosed in the description of the invention below. To achieve this aim the invention discloses an elevator system according to claim 1. The preferred embodiments of the invention are described in the dependent claims. Some inventive embodiments and inventive combinations of the various embodiments are also presented in the descriptive section and also in the drawings of the present application.

### SUMMARY OF THE INVENTION

The elevator system according to the invention comprises an elongated moving suspension member, a load-receiving part suspended on the suspension member, a counterweight suspended on the suspension member for supporting the load-receiving part, an elongated traction member for exerting a pulling force on the load-receiving part and on the counterweight, a drive unit, with which the load-receiving part is driven by pulling the aforementioned traction member and also one or more guide rails, along the path of movement determined by Which the load-receiving part is moved in the elevator hoistway. The aforementioned drive unit is disposed to the side of the path of movement of the aforementioned load-receiving part. In the elevator system according to the invention the functions of the suspension member and of the traction member are separated from each other such that the suspension member is used for suspending the load-receiving part and the counterweight, and the traction member is used for pulling the load-receiving part and the counterweight.

Consequently, the invention enables space saving in the elevator hoistway, on the one hand, because when disposing the drive unit on the side of the path of movement of the load-receiving part (such as the elevator car or a raisable pallet) and not at the end of the path of movement, it is not necessary to reserve a separate space/safety distance for the drive unit in the end zone of the elevator hoistway at the end of the path of movement and, on the other hand, also because since the traction member according to the invention, which is separate to the suspension member, does not need to bear the suspension forces exerted on the suspension member, the dimensioning of the traction member and of the drive unit transmitting power to the traction member can be optimized. By optimizing the dimensioning, the drive unit can be made to be extremely thin in the radial direction, in which case it also fits into a narrower space than in prior-art, between the path of movement of the load-receiving part and the wall of the elevator hoistway. Space-efficiency can also be improved by disposing the drive unit under the counterweight.

In a preferred embodiment of the invention the elevator system comprises a mechanical safety device, which is configured to be brought into interaction with the load-receiving part and/or with the counterweight when the load-receiving part arrives at the end of its path of movement, and the drive unit is disposed by the side of the path of movement of the load-receiving part in the proximity of the end of the path of movement such that at least a part of the approaching load-receiving part is situated on the side of the drive unit already before the load-receiving part and/or the counterweight is in interaction with the aforementioned mechanical safety device. In this case the load-receiving part can be driven extremely close to the end of the elevator hoistway and the mechanical safety device can be designed according to design principles for small top clearances and/or bottom clearances of the elevator hoistway, in which case when the top/bottom safety spaces become smaller the proportion of space available for transporting elevator passengers out of the total volume of the elevator hoistway increases. A reduced end buffer, for instance polyurethane buffer, can be used as a mechanical safety device; on the other hand, also e.g. a safety gear, which stops the load-receiving part by gripping against a guide rail, can be used as a mechanical safety device. In some embodiments a machinery brake is used as a confirmative safety device of the top safety space of the elevator hoistway. In monitoring the speed of the load-receiving part, limit values for the maximum permitted speed that decrease towards the end of the path of movement of the load-receiving part can be used. Monitoring of the speed of the load-receiving part can be implemented by bringing a mechanical safety device into interaction with the load-receiving part when it is detected that the speed of the load-receiving part exceeds the aforementioned limit value for maximum permitted speed. In this case the maximum permitted speed of the load-receiving part is smaller, the closer to the end of the path of movement the load-receiving part is situated, and therefore the movement of the load-receiving part near the end of the path of movement is controlled and safe regardless of the small top clearances and bottom clearances of the elevator hoistway.

In one preferred embodiment of the invention the load-receiving part is arranged to be moved along an essentially vertical path of movement, and the traction member is suspended on the load-receiving part and on the counterweight for exerting a downward-pulling force on the load-receiving part/counterweight. In this case the weight of the elevator car/counterweight suspended in the elevator hoistway is not exerted directly on the traction member, owing to which the dimensioning of the traction member and of the drive unit transmitting power to the traction member can be reduced. In one preferred embodiment of the invention the elevator system comprises two parallel traction members, which are suspended on the load-receiving part and on the counterweight. In a preferred embodiment of the invention the drive unit is configured to drive the load-receiving part by pulling the aforementioned two parallel traction members. In one embodiment the aforementioned parallel traction members are suspended on the load-receiving part from suspension points, which are disposed on opposite sides of the load-receiving part, above the bottommost level of the load-receiving part, most preferably above the floor level of the load-receiving part. In this way the force effect of the traction members is thereby exerted symmetrically in the load-receiving part, so that detrimental torsion is not exerted on the load-receiving part. In addition, the selection of the suspension points above the bottommost level floor level of the load-receiving part enables extension of the area of movement of the load-receiving part to closer to the bottom end of the elevator hoistway.

In one preferred embodiment of the invention the mechanical safety device is an end buffer, which is disposed at the end of the path of movement of the load-receiving part, on a collision course with the load-receiving part approaching the end of the path of movement. In addition to, or instead of, the aforementioned end buffer, e.g. an end buffer configured to be on a collision course with the counterweight, a safety gear stopping the load-receiving part and/or a machinery brake of the hoisting machine of the elevator can be used as a mechanical safety device. In a preferred embodiment of the invention the counterweight is shallower than the load-receiving part. In this case space remains below the counterweight for the drive unit also in a situation in which the load-receiving part is situated at the top end of its path of movement.

In one preferred embodiment of the invention the mechanical safety device is configured to be brought into interaction with the load-receiving part arriving at the bottom end of an essentially vertical path of movement. In this case it must also be taken into account in the selection/dimensioning of the safety device that the combined weight of the load-receiving part and the load acts downwards in the direction of movement of the load-receiving part, which increases the collision force between the load-receiving part and the mechanical safety device.

In one preferred embodiment of the invention a mechanical safety device is configured to be brought into interaction with the load-receiving part and/or with the counterweight when the load-receiving part arrives top end of the aforementioned essentially vertical path of movement. In this case, on the other hand, the combined weight of the load-receiving part and the load acts in the opposite direction with respect to the direction of movement of the load-receiving part, which reduces the collision force between the load-receiving part and the mechanical safety device.

In one preferred embodiment of the invention the drive unit is disposed in the proximity of the bottom end of the essentially vertical path of movement of the aforementioned load-receiving part. In this case, inter alia, installation work, repair work and servicing work on the drive unit can be performed from the pit of the elevator hoistway, in which case a separate service platform is not needed as a work base for a serviceman, and also components and tools do not need to be lifted up into the elevator hoistway. In one preferred embodiment of the invention the traction member travels from the counterweight down to the traction sheave of the drive unit, and passing around the traction sheave onwards to a diverting pulley, below which the traction member passes around continuing its passage onwards up to the load-receiving part.

In one preferred embodiment of the invention the drive unit comprises a traction sheave for pulling the traction member, and also an elevator motor. Furthermore, the drive unit preferably comprises a power supply device of the elevator motor. The power supply device of the elevator motor can be integrated mechanically and electrically into the drive unit, or the power supply device of the elevator motor can also be separate from the drive unit, in which case the power supply device can be disposed in the proximity of the drive unit in the elevator hoistway. In a preferred embodiment of the invention the drive unit also comprises a machinery brake, most preferably at least two machinery brakes, for braking the movement of the traction sheave of the drive unit. In a preferred embodiment of the invention the axis of rotation of the elevator motor is in the direction of the outer wall of the load-receiving part, in which case the path of movement of the load-receiving part can travel beside the drive unit and the space requirement of the drive unit is extremely small.

In a preferred embodiment of the invention the aforementioned elongated traction member/traction members is/are preferably toothed belts. One advantage, among others, of a toothed belt compared to a traction belt or traction rope engaging by frictional traction is that the tractive force between the traction sheave and the belt is not able to weaken if the friction coefficient for some reason decreases. The friction coefficient might decrease, for example, if a foreign substance, such as oil, gets between the traction sheave and the belt/rope. The friction coefficient might also decrease e.g. owing to wear of the coating of the traction sheave.

In a preferred embodiment of the invention the drive unit comprises two traction sheaves on the same shaft fitted at a distance from each other. Of the aforementioned traction sheaves, the first is arranged to pull the first of the aforementioned parallel traction members, and the second is arranged to pull the second of the aforementioned parallel traction members.

In a preferred embodiment of the invention the aforementioned load-receiving part is an elevator car, and at least apart of the drive unit is situated at the side of the elevator car when the elevator car is at the point of the door zone of the bottommost stopping floor. In this case the elevator system according to the invention can also be fitted into an elevator hoistway having shallow bottom clearances (i.e. the pit of the elevator hoistway is exceptionally shallow or is even completely missing). The door zone of a stopping floor means the position into which elevator passengers from the stopped elevator can transfer out of the elevator car/into the elevator car.

In one preferred embodiment of the invention the counterweight is shallower than the load-receiving part. In this case when the elevator car is in its top position, space remains under the counterweight for the drive unit also when using 1:1 suspension.

In one preferred embodiment of the invention each aforementioned traction member travels from the counterweight downwards to the drive unit, passing around the traction sheave comprised in the drive unit and onwards to a diverting pulley which is fitted into its position in a manner allowing rotation in the proximity of the bottom end of the essentially vertical path of movement of the aforementioned load-receiving part, and under the diverting pulley in question upwards to the load-receiving part.

In one preferred embodiment of the invention the aforementioned diverting pulley is disposed to the side of the path of movement of the aforementioned load-receiving part.

In one preferred embodiment of the invention each aforementioned diverting pulley is at least partly at the side of the load-receiving part when the load-receiving part is at the point of the bottommost floor landing.

The elevator system according to the invention can also comprise two or even more separate counterweights, and the counterweights can be suspended on the same movable suspension member.

The preceding summary, as well as the additional features and additional advantages of the invention presented below, will be better understood by the aid of the following description of some embodiments, said description not limiting the scope of application of the invention.

### BRIEF EXPLANATION OF THE FIGURES

FIG. 1 presents a schematic side view of an embodiment of an elevator system.

FIG. 2 presents the embodiment of FIG. 1 as viewed from below.

FIG. 3 presents an oblique top view of the embodiment of FIG. 1.

FIG. 4 presents schematically an oblique top view of a second embodiment of an elevator system.

### MORE DETAILED DESCRIPTION OF PREFERRED EMBODIMENTS OF THE INVENTION

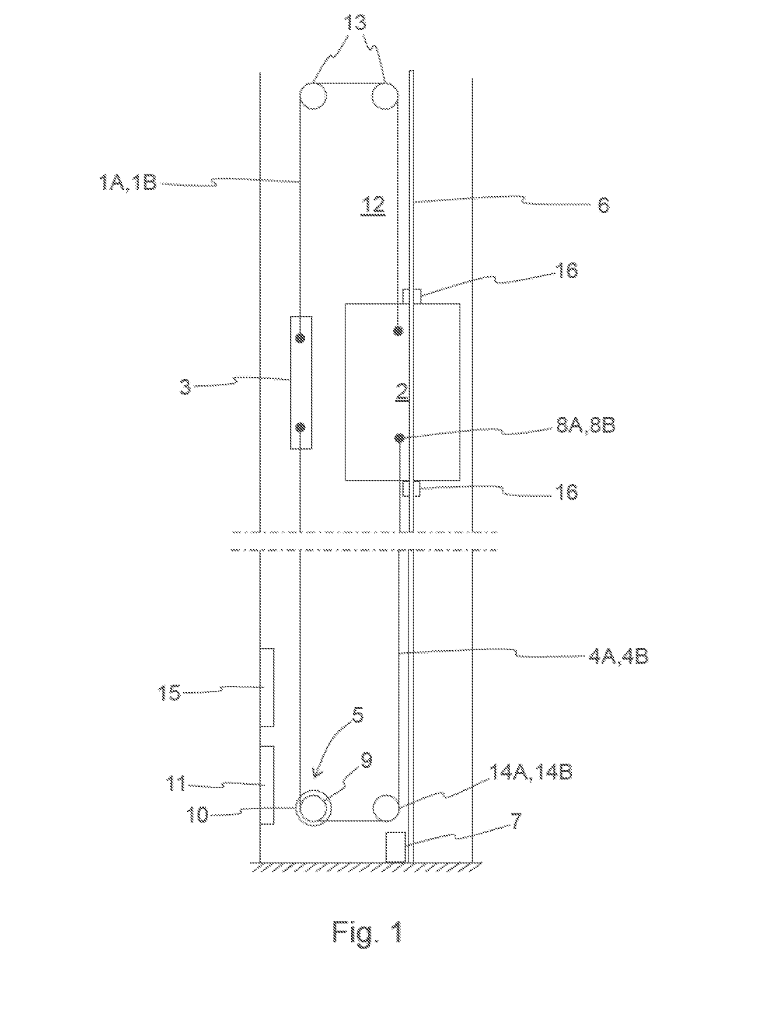

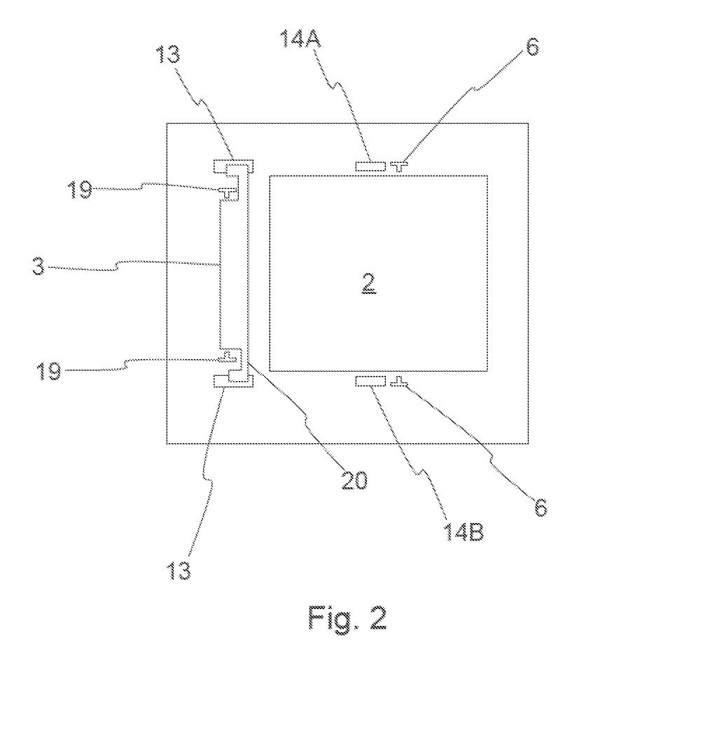

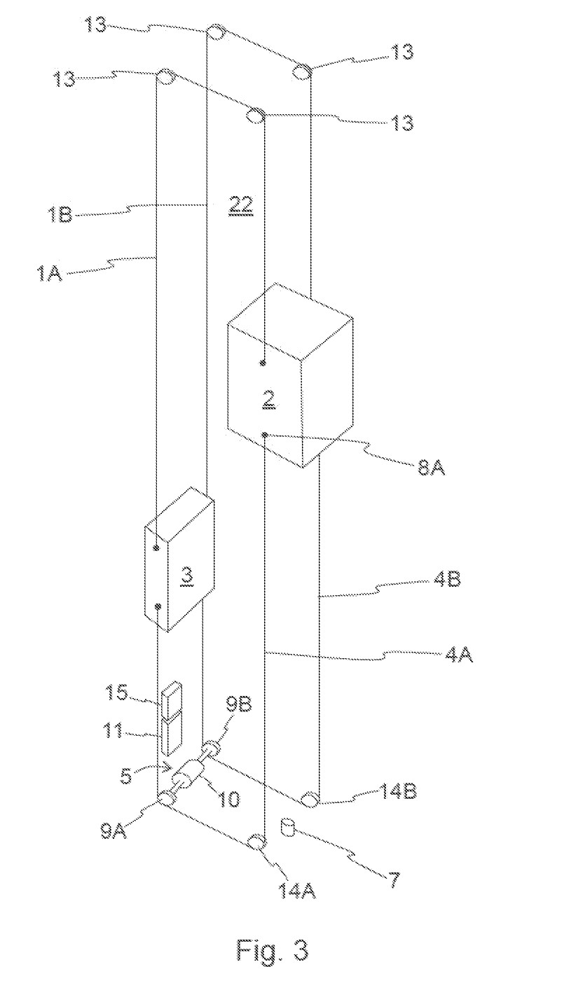

FIG. 1 presents a schematic side view of an embodiment of an elevator system having 1:1 suspension. Additionally, FIGS. 2 and 3 present the embodiment of FIG. 1 as viewed from directly below and obliquely from above. In the elevator system of FIG. 1 the elevator car 2 and the counterweight 3 are suspended in the elevator hoistway 12 with parallel suspension ropes 1A, 1B, which travel via diverting pulleys 13 fixed in a manner allowing rotation to the top part of the elevator hoistway. Steel ropes, composite ropes or a belt in which load-bearing strands such as e.g. metal strands, e.g. steel strands, or non-metallic strands, for instance glass fiber strands, are configured inside a matrix made of polyurethane or corresponding, can, inter, alia, be used as suspension ropes 1A, 1B. In this embodiment of the invention the suspension ropes 1A, 1B are fixed to the elevator car 2 and to the counterweight 3 from suspension points, which are disposed on opposite sides of the elevator car/counterweight, below the roof level of the elevator car 2/topmost point, of the counterweight, which suspension points also, for their own part, enable continuation of the movement of the elevator car 2/counterweight 3 to closer to the top end of the elevator hoistway 12 than in prior art. On the other hand, all the suspension ropes 1A, 1B could be fixed to the same fixing point on the top part of the elevator car 2/counterweight 3. This type of solution simplifies the suspension arrangement, because in this case all the suspension ropes of the elevator car 2/counterweight 3 can be taken in one rope bundle instead of two parallel rope bundles, in which case the number of diverting pulleys 13 needed in the top part of the elevator hoistway for suspending the suspension ropes 1A, 1B is halved.

Two parallel toothed belts 4A, 4B are suspended on the elevator car 2 and on the counterweight 3, which travel via, the traction sheaves 9A, 9B that are disposed at a distance from each other on the shaft of the elevator motor 10 in connection with the bottom end of the elevator hoistway 12 and also via the diverting pulleys 14A, 14B that are fixed in a manner allowing rotation in connection with the bottom end. The toothed belts are tensioned between the elevator car 2 and the traction sheave 3 to be taut such that the toothed belts exert a downward-pulling force on the elevator car 2/counterweight 3 when the toothed belts are pulled by rotating the traction sheaves 9A, 9B with the elevator motor 10. The elevator motor 10 can be e.g. a permanent-magnet synchronous motor, a squirrel-cage motor or a reluctance motor. The designation drive unit 5 is used here to refer to the entity formed by the traction sheaves 9A, 9B, the elevator motor 10, the shaft of the elevator motor and the machine bedplate (not presented in FIGS. 1-3). In addition, the drive unit 5 usually comprises two or more electromagnet brakes, with which the movement of the traction sheaves 9A, 9B is braked.

The power supply to the elevator motor occurs from the electricity network with a frequency converter 11. With the frequency converter 11 the power supply between the elevator motor 10 and the electricity network can be adjusted steplessly in both directions, which also enables stepless speed control. The speed regulating loop of the frequency converter 11 adjusts the speed of the traction sheaves 9A, 9B, and thereby the speed of the elevator car 2, towards the target value for speed calculated by the elevator control unit 15. The elevator control unit 15 forms the aforementioned target value for speed on the basis of elevator calls given by elevator passengers such that with the elevator it is possible to drive in the building from one floor to another in the manner required by the elevator calls.

Vertical guide rails 6, which are disposed on opposite sides of the elevator car, are fixed into position with guide rail brackets to the wall part of the elevator hoistway 12. Further, guide shoes 16 moving along with the elevator car are fitted in connection with the elevator car, such as sliding guide shoes or roller guide shoes, which engage with the aforementioned guide rails 6 such that the guide shoes 16 move along the guide rails 6 when the elevator car 2 travels along the vertical path of movement determined by the position of the guide rails 6.

Guide rails 19 are also fixed to the wall part of the elevator hoistway for guiding the movement of the counterweight 3. The guide rails 19 of the counterweight 3 can be disposed at the sides of the counterweight 3 or behind the counterweight 3 in the space between the wall part of the elevator hoistway 12 and the counterweight 3. In FIG. 2 the guide rails 19 are disposed on the sides of the counterweight 3, and the counterweight 3 of FIG. 2 also comprises fixing arms 20 circling around the guide rail 19 for fixing the suspension ropes 1A 1B and the toothed belts 4A, 4B.

In the elevator system of FIG. 1 the functions of the suspension ropes 1A, 1B and of the toothed belts 4A, 4B are separated from each other such that the suspension ropes 1A, 1B are used only for suspending/supporting the elevator car 2 and the counterweight 3, and the toothed belts 4A, 4B only for pulling the elevator car 2 and the counterweight 3. For this reason the toothed belts 4A, 4B and the drive unit 5 also do not need to bear the weight of the elevator car 2, the counterweight 3 and the elevator ropes 1A, 1B, in which case the drive unit 5 could be designed to be extremely thin in the radial direction and at the same time elongated in the direction of the axis of rotation such that the drive unit 5 could be disposed in the bottom end zone of the elevator hoistway 12 in the narrow space remaining between the path of movement of the elevator car 2 and the wall part of the elevator hoistway 12, by bolting the drive unit 5 to the floor of the elevator hoistway 12. The frequency converter 11 and the elevator control unit 15, which are flat in shape, are fixed to the wall part of the elevator hoistway 12 in the proximity of the drive unit 5 such that the frequency converter 11 and the elevator control unit 15 are disposed on the side of the path of movement of the elevator car 2 in the same space with the drive unit 5. An end buffer 7 is used as a safety device of the bottom end zone of the elevator hoistway, which end buffer is disposed at the bottom end of the path of movement of the elevator car 2, on a collision course with the elevator car 2 approaching the bottom end of the elevator hoistway 12. A reduced polyurethane buffer intended for shallow safety space solutions functions as the end buffer 7 of the elevator car 2. The short length of the reduced polyurethane buffer 7 enables continuation of the path of movement of the elevator car 2 to close to the end of the elevator hoistway 12 such that at least a part of the elevator car 2 approaching the end is situated on the side of the elevator control unit 15, the frequency converter 11 and the drive unit 5 already before the elevator car 2 collides with the aforementioned reduced polyurethane buffer 7. The toothed belts 4A, 4B are suspended on the elevator car 2 from suspension points 8A, 8B, which are disposed on opposite sides of the elevator car, above the floor level of the elevator car 2, which suspension points also, for their own part, enable continuation of the movement of the elevator car 2 to closer to the end of the elevator hoistway 12 than in prior art.

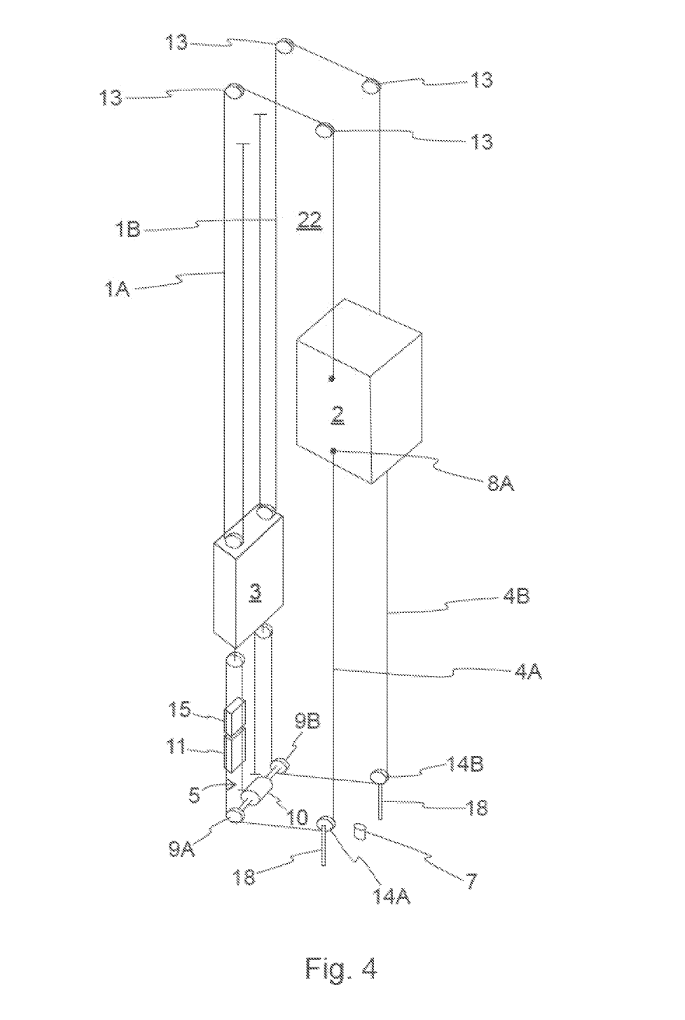

FIG. 4 presents a second embodiment of the elevator system. In the elevator system of FIG. 4 the counterweight 3 is suspended on suspension ropes 1A, 1B with diverting pulleys 21A, 21B, and the suspension ropes 1A, 1B travel up from the diverting pulleys 21A, 21B to a support structure of the top part of the elevator hoistway 12. The toothed belts 4A, 4B are suspended on the counterweight 3 with diverting pulleys 22A, 22B, from which the toothed belts travel downwards to a support structure in the bottom part of the elevator hoistway. Here, with the 2:1 suspension solution described the length of the path of movement of the counterweight 3 can be limited; by limiting the length of the path of movement, on the other hand, it is easier to prevent the counterweight 3 colliding with the drive unit 5 in the bottom end of the elevator hoistway 12.

In addition, in FIG. 4 the diverting pulleys 14 of the bottom end zone of the elevator hoistway 12 are raised upwards with a support beam 18, in which case the contact angle of the toothed belts 4 on the traction sheave 9A, 9B increases, thus improving the grip of the traction sheave. The support beam 18 and the diverting pulley 14 are to the side of the path of passage of the elevator car 12 such that the elevator car 12 is able to descend to alongside the diverting pulley 14 and the support beam 18. The solution is particularly well suited also to elevators in which the elevator car 2/counterweight 3 are pulled with traction belts, which engage with the traction sheave 9A, 9B by frictional traction, instead of toothed belts 4A, 4B.

The drive unit 5 and the diverting pulleys 14A, 14B and also possible support beams 18 are preferably integrated into the same module or they are mechanically joined together.

The invention is not only limited to be applied to the embodiments described above, but instead many variations are possible within the scope of the inventive concept defined by the claims.

1. An elevator system, comprising:
an elongated suspension member;
a load-receiving part suspended on the suspension member;
a counterweight suspended on the suspension member for supporting the load-receiving part;
an elongated traction member for exerting a pulling force on the load-receiving part and on the counterweight;
a drive unit, with which the load-receiving part is driven by pulling the traction member; and
one or more guide rails, along the path of movement determined by which the load-receiving part is moved,
wherein the drive unit is disposed to the side of the path of movement of the load-receiving part.

2. The elevator system according to claim 1, wherein the elevator system comprises a mechanical safety device, which is configured to be brought into interaction with the load-receiving part and/or the counterweight when the load-receiving part arrives at the end of its path of movement; and
wherein the drive unit is disposed by the side of the path of movement of the load-receiving part in the proximity of the end of the path of movement such that at least a part of the approaching load-receiving part is situated on the side of the drive unit already before the load-receiving part and/or the counterweight is in interaction with the mechanical safety device.

3. The elevator system according to claim 1, wherein the traction member is suspended on the load-receiving part and on the counterweight.

4. The elevator system according to claim 3, wherein the elevator system comprises two parallel traction members, which are suspended on the load-receiving part and on the counterweight.

5. The elevator system according to claim 4, wherein the parallel traction members are suspended on the load-receiving part from suspension points, which are disposed on opposite sides of the load-receiving part, above the floor level of the load-receiving part.

6. The elevator system according to claim 4 or 5, claim 4, wherein the drive unit is configured to drive the load-receiving part by pulling the two parallel traction members.

7. The elevator system according to claim 1, wherein a mechanical safety device is an end buffer, which is disposed at the end of the path of movement of the load-receiving part, on a collision course with the load-receiving part approaching the end of the path of movement.

8. The elevator system according to claim 1, wherein the load-receiving part is arranged to be moved along an essentially vertical path of movement.

9. The elevator system according to claim 8, wherein the traction member is arranged to exert a downward pulling force on the load-receiving part/counterweight.

10. The elevator system according to claim 8, wherein a mechanical safety device is configured to be brought into interaction with the load-receiving part arriving at the bottom end of the essentially vertical path of movement.

11. The elevator system according to claim 8, wherein the mechanical safety device is configured to be brought into interaction with the load-receiving part and/or the counterweight when the load-receiving part arrives at the top end of the essentially vertical path of movement.

12. The elevator system according to claim 8, wherein the drive unit is disposed under the counterweight.

13. The elevator system according to claim 1, wherein the drive unit is disposed in the proximity of the bottom end of the essentially vertical path of movement of the load-receiving part.

14. The elevator system according to claim 1, wherein the drive unit comprises a traction sheave for pulling the traction member.

15. The elevator system according to claim 1, wherein the drive unit comprises an elevator motor.

16. The elevator system according to claim 15, wherein the axis of rotation of the elevator motor is in the direction of the outer wall of the load-receiving part.

17. The elevator system according to claim 1, wherein the drive unit comprises a power supply device for the elevator motor.

18. The elevator system according to claim 1, wherein the one or more traction members is a toothed belt.

19. The elevator system according to claim 4, wherein the drive unit comprises two traction sheaves fitted on the same shaft at a distance from each other; and
wherein of the traction sheaves, the first is arranged to pull the first of the parallel traction members and the second of the traction sheaves is arranged to pull the second of the parallel traction members.

20. he elevator system according to claim 1, wherein the load-receiving part is an elevator car; and
wherein a part of the drive unit is situated at the side of the elevator car when the elevator car is at the point of the door zone of the stopping floor.

21. The elevator system according to claim 1, wherein the counterweight is shallower than the load-receiving part.

22. The elevator system according to claim 13, wherein each traction member travels from the counterweight downwards to the drive unit, passing around the traction sheave comprised in the drive unit and onwards to the diverting pulley which is fitted into its position in a manner allowing rotation in the proximity of the bottom end of the essentially vertical path of movement of the load-receiving part, and under the diverting pulley upwards to the load-receiving part.

23. The elevator system according to claim 22, wherein the diverting pulley is disposed to the side of the path of movement of the load-receiving part.

24. The elevator system according to claim 23, wherein each diverting pulley is at least partly at the side of the load-receiving part when the load-receiving part is at the point of the bottommost floor landing.
